(19) United States
(12) Patent Application Publication
(10) Pub. No.: US 2026/0337961 A1
(43) Pub. Date: Oct. 29, 2026

(54) ACOUSTIC TECHNOLOGY FOR ROOMS, SUCH AS CONCERT HALLS, THAT CAN BE VARIED BETWEEN A SOUND-ABSORPTIVE AND A SOUND REFLECTIVE STATE

(71) Applicant: Niels Werner ADELMAN-LARSEN, Copenhagen (DK)

(72) Inventor: Niels Werner ADELMAN-LARSEN, Copenhagen (DK)

(21) Appl. No.: 19/120,158

(22) PCT Filed: Oct. 2, 2023
(86) PCT No.: PCT/DK2023/000237

§ 371 Date: Apr. 10, 2025

(30) Foreign Application Priority Data
Oct. 11, 2022 (DK) PA202200924

(51) Int. Cl. E04B 1/99; E04B 1/84; E04B 1/86; G10K 11/162

(52) U.S. Cl. CPC E04B 1/994; E04B 1/86; G10K 11/162; E04B 2001/8433

(57) ABSTRACT

The present invention relates to a panel for attachment to boundaries of a room, such as a concert hall, the panel comprising a panel board (1, 28) provided with through openings (2, 29) between a first surface (1′, 28′) and a second surface (1″, 28″) of the panel board (1, 28); a closing unit (3, 14, 30) provided opposite to and facing the second surface (1″, 28″) of the panel board (1, 28), such that the distance between the second surface (1″, 28″) of the panel board (1, 28) and the closing unit (3, 14, 30) can be varied between a closed state, in which the closing unit (3, 14, 30) closes the through openings (2, 29) in the panel board (1, 28) and an open state, in which the closing unit (3, 14, 30) does not close the through openings (2, 29) in the panel board; where the closing unit (3, 14, 30) in first regions (15, 32) of the closing unit that in the closed state of the panel cover the through openings (2, 29) in the panel board (1, 28) is substantively sound impenetrable, so that sound is substantively prevented from being transmitted through the through openings (2, 29) in the panel board (1, 28) in the closed state of the panel; and the closing unit (3, 14, 30) in one or more second regions (4, 12, 13, 17, 37, 38) of the closing unit (3, 14, 30) that in the closed state of of the panel are not totally or partly coinciding with said through openings (2, 29) in the panel board (1, 28) allow transmission of sound through the closing unit.

The invention further relates to a device comprising a panel of the invention and a system of such devices.

### TECHNICAL FIELD

The present invention relates generally to the field of acoustic covering devices and corresponding systems for boundaries of a room, particularly for concert halls and auditoria, and more specifically to such devices and systems that can be varied between a state in which they absorb sound energy and a state in which they reflect sound energy and with the possibility that such mechanisms allow such devices and systems to be varied gradually between these two states.

### BACKGROUND OF THE INVENTION

In halls for music, it is strongly desirable to be able to vary the reverberation time (RT) due to the fact that various genres of music need different RT to obtain the best possible perceived sound quality of for instance an orchestra or vocalists performing in the hall. In the low frequency bands, especially the 125 Hz octave band it should preferably be possible to reduce the RT by about 40% or more.

Concert halls often have large volumes and according to Sabine's formula, a reduction of RT by 40% requires a very large area of the boundaries of the hall to be covered by variable acoustic surfaces which can reflect respectively absorb sound.

In the prior art there has been disclosed acoustic panels or modules with variable sound absorption properties, none of which have proven successful for concert halls except the ones filed by the inventor. Some prior art has further proven too costly for such large surface areas for the budget of halls for music.

One example of prior art that is able to a very large extend to vary the low frequency RT of halls is disclosed in the applicant's own prior patent application WO 2018/162014 A1 and the modules and systems of modules disclosed herein are very well suited for instance for rooms designed for psychoacoustic listening tests, which rooms typically are of considerably smaller volume than concert halls and which therefore required a much more limited number of panels (modules) than would be required in a concert hall. The solution however—although acoustically well suited-gets quite expensive for the budget of concert halls.

### OBJECTS OF THE INVENTION

On the above background, it is an object of the present invention to provide a technology that comprises panels that are configured to be used in devices or systems designed to vary the RT of a concert hall, which technology is simpler and less costly to manufacture, maintain and replace than the prior art panels or modules, such that the costs associated with purchasing, installing and maintaining and replacing the required very large areas of panels can be kept at an affordable level.

### DEFINITION OF TERMS USED IN THE FOLLOWING

In the following description as well as in the claims the terms “technology”, “panel”, “device” and “system” are used. In the present context these terms are defined as follows:

The term “technology” covers both panels, devices and systems as well at methods that use such physical entities.

The term: “device” is a physical entity that can absorb or reflect sound energy at least in a given frequency region. A device can either be in a state where it does not absorb sound energy (in the following referred to as the “closed state”) or it can be in a state where it absorbs sound energy (in the following referred to as the “open state”). In the open state, the device can be more or less opened up to a certain maximally open state and this transition between the entirely closed state and the maximally open state can take place gradually or in steps, if desired, thereby changing the degree of sound absorption in the open state.

A “device” comprises a “panel” that can be either in a closed state wherein sound energy cannot propagate through the panel or a more or less open state in which sound energy can propagate through the panel to an extent that can be controlled within certain limits. The device furthermore comprises opening and closing means that are configured to vary the state of sound propagation through the panel as well as operating means configured to drive the opening and closing means. The device furthermore comprises sound absorbing means that are able to absorb at least some of the sound energy that propagates through the panel in its open state.

A “system” comprises a plurality of “devices” or “panels” where the system is configured to be mounted on chosen boundaries of a room, such as on walls and/or the ceiling. A system may furthermore comprise drive mechanisms that are configured to operate the operating means of the devices or panels as described above between a closed state and more or less open states.

### DISCLOSURE OF THE INVENTION

The above and further objects and advantages are obtained by the panels and systems of such panels according to the present invention.

According to the present invention there is provided a technology for varying the RT of a large room having large wall and/or ceiling areas designed for performing different kinds of music. According to the invention, the advantage of simplicity and low production costs of the technology is inter alia obtained by reducing the number of hinges and other complex mechanical components in the panels for instance compared with the modules disclosed in the applicant's prior application WO 2018/162014 A1. Hence, according to the present invention, for instance the 4 closing members and the corresponding 12 hinges described in the above example of prior art is reduced to only one single closing unit and one or only few hinges (or similar mechanical structure). Furthermore, by using a board of a large size as the actual front face of the structure, a technology is provided that meets the wish for a simpler and thereby less pricy solution to the problem of providing the desired variability of the RT and at the same time obtain an aesthetic appearance of the boundaries of for instance a concert hall provided with the panels according to the present invention.

According to a first aspect of the present invention there is provided a panel for attachment to boundaries of a room, such as a concert hall, the panel comprising
a panel board provided with through openings between a first surface and a second 25 surface of the panel board;
a closing unit provided opposite to and facing the second surface of the panel board, such that the distance between the second surface of the panel board and the closing unit can be varied between a closed state, in which the closing unit closes the through openings in the panel board and an open state, in which the closing unit does not close 30 the through openings in the panel board;
wherein:
the closing unit in first regions of the closing unit that in the closed state of the panel cover the through openings in the panel board is substantively sound impenetrable, so
ugh openings in the panel board in the closed state of the panel; and
the closing unit in one or more second regions of the closing unit that in the closed state of of the panel are not totally or partly coinciding with said through openings in the panel board allow transmission of sound through the closing unit.

In a preferred embodiment of the first aspect, the panel comprises only one single closing unit configured to open and close all through openings in the panel board.

In an embodiment of the first aspect, the closing unit is provided with through openings that are displaced relative to the through openings in the panel board, such that when the panel is in the closed state, the through openings in the closing unit do not overlap the through openings in the panel board.

According to the invention, the through openings in the closing unit are provided in order to ease sound transmission to a sound absorbing material or other sound absorbing device(s) provided behind the closing unit in the absorptive (open) state of the panel, thereby enhancing the efficiency of the device in the open state by improving the absorption significantly.

In an embodiment of the first aspect, the variation between the closed state of the panel and the open state of the panel takes place gradually and such that the panel can be either in an entirely closed state or an entirely open state (or maximally open state, which is determined by the specific design of the panel) or in any or a number of intermediate states, for example half-opened. Thus, the degree of sound transmission from one side (the front side) of the panel via the through openings in the panel board and from the opposite (rear) side of the panel board to a sound absorbing material or device can in this embodiment be varied gradually between substantially no sound transmission to the maximum sound transmission including a number of or any intermediate degrees of sound transmission through the panel affecting deliberately the absorption curve in the open state of the device.

In an embodiment of the first aspect, the closing unit is pivotally attached to the panel board, such that the closing unit changes the panel between a closed state and an open state, when the closing unit pivots relative to the panel board.

In an embodiment of the first aspect, one longitudinal end of the closing unit is pivotally linked at one or more points close to the circumference of the panel board by means of a hinge member or similar mechanical device.

In an embodiment of the first aspect, the closing unit is shifted or tilted away from the through openings of the panel board to improve further high frequency absorption.

In an embodiment of the first aspect one longitudinal end of the closing unit is pivotally linked to a corresponding longitudinal end of the panel board by means of a hinge member or similar mechanical device.

In an embodiment of the first aspect, the panel is configured such that the closing unit can undergo a displacement substantially in parallel with the second surface of the panel board such that the closing unit can be displaced a distance between a position in which it closes the through openings in the panel board and a position in which it opens the through openings in the panel board. This displacement can also take place gradually.

In an embodiment of the first aspect, permanent magnetic means are provided on the second surface of the panel board around the through openings and the closing unit is (at least in a region corresponding the the position of the permanent magnets) made of, or equipped with, a material that can be attracted by the magnetic means, such that the magnetic means, in the closed state of the panel, maintains the closing unit is acoustically tight contact with the second surface of the panel board.

In an embodiment of the first aspect, electro-magnetic means are provided on the second surface of the panel board around the through openings and the closing unit is (at least in a region corresponding the the position of the electro-magnets) made of a material that can be attracted by the magnetic means, such that the magnetic means, in the closed state of the panel, maintains the closing unit is acoustically tight contact with the second surface of the panel board.

In an embodiment of the first aspect, the magnetic means is supplemented by rubber gaskets or gaskets made of another suitable flexible/compressible material in order to ensure an acoustically tight closing.

In an embodiment of the first aspect, first mechanical means are provided on the second surface of the panel board around the through openings and the closing unit is (at least in a region corresponding the the position of the mechanical means) provided with corresponding second mechanical means configured for retaining engagement with the the first mechanical means, such that the mechanical means, in the closed state of the panel, maintains the closing unit is acoustically tight contact with the second surface of the panel board.

In an embodiment of the first aspect, the mechanical means is supplemented by rubber gaskets or gaskets made of another suitable flexible/compressible material in order to ensure an acoustically tight closing. In an embodiment of the first aspect, mechanical engagement means are provided on the second surface of the panel board around the through openings and wherein the closing unit at least in a region corresponding the the position of the mechanical means is provided with cooperating releasable mechanical engagement means such that the mechanical engagement means, in the closed state of the panel, maintains the closing unit is acoustically tight contact with the second surface of the panel board.

In an embodiment of the first aspect, the closing unit is one single plate provided with through openings.

In an embodiment of the first aspect, the closing unit comprises a number of separate closing members or plates, where adjacent closing members or plates are separated from each other by a gap of a width w, thereby forming the through openings in the closing unit. Adjacent plates are in this embodiment mutually connected connecting members. In an embodiment of the first aspect the panel board on the first surface is provided with a sheet of veneer or other aesthetically attractive surface, which sheet is provided with through openings corresponding to the through openings in the panel board, such that sound from the surroundings in front of the veneer can propagate through the through openings in the veneer and the corresponding through openings in the panel board and reach a sound absorbing material provided in the space between the panel board and the boundary of the room.

In an embodiment of the first aspect the panel comprises actuator means, such as an electro-motor configured to move the closing unit between the open and closed states of the panel. In an embodiment of the first aspect, the closing unit in at least some of the regions that in the closed state of the panel coincides with the through openings in the the panel board is provided with elements that extend from the surface of the closing unit that faces the panel board, which elements are configured such that they extend through at least some of the through openings in the front panel and to a distance in front of the front panel when the panel is in the closed state.

According to a second aspect of the present invention there is provided a device for varying the reverberation time (RT) of a room, such as a concert hall, where the device comprises: a panel according to the first aspect;
a sound absorbing device, such as a sound absorbing material, provided such that the closing unit can control the propagation of sound energy from the surroundings of the device to the sound absorbing device;
attachment means configured to attach the panel to a boundary of the room such that a space is formed between the panel and the boundary in which space the sound absorbing device is provided;
operator means configured to open or close the closing unit; and
surrounding means that prevent sound energy to reach the absorption device in the closed state of the device.

According to a third aspect of the present invention there is provided an acoustic covering system for boundaries of a room, wherein the system comprises:
one or more sound absorbing devices according to the second aspect;
actuator means, such as electric motors, configured to drive the operator means of the devices between the open and closed states of the panel and vice versa.

According to an embodiment of the third aspect, the actuators are configured to maintain the closing units of the panels in one or more states between between an entirely closed state and a maximally open state of the closing units.

The present invention provides an acoustic technology that has the very important advantages of being cheaper to manufacture, maintain, repair or replace than the prior art technology mentioned in the background of the invention.

Furthermore, the present invention provides an acoustic technology that makes it possible to vary the reverberation time of rooms especially at (but not exclusively) low frequencies to a very large extend, such that a room or other space in which the technology of the invention is installed can be adapted to a broad range of different acoustic requirements. Thus, for instance in arenas that are used both for sports event and for performance of amplified concerts, the reverberation time can be relatively long at sports events and relatively short for amplified music performances.

In order to ensure the best possible performance of the acoustic technology according to the invention, the panel board and the closing unit must have a high mass per unit area. This makes HDF products as for instance fiber cement as well as the company Rockwool's “Rockpanel®” well suited for this purpose. It is furthermore possible to attach a metal plate (such as a steel plate) to the rear surface of a MDF plate in order to increase its mass per unit area.

In an embodiment of the invention, both the panel board and the closing unit can have the form of an arch, such that the sound impinging on the front surface of the panel board (or on a sheet of veneer attached to the front surface of the panel board) becomes diffused, especially in the reflective (i.e., closed) state of the panel of the invention.

Thus, the earlier mentioned prior art technology described in the background of the invention uses numerous closing units, each provided with a plurality of hinges (4 closing units with a total of 12 hinges) in each panel board and these hinges are both expensive to manufacture and to install. In this prior art technology, the dimensions of the panel board are typically 2.4 m×0.6 m, thus having an area of 1.44 m². Consequently, covering an area of 1.44 m² requires 4 closing units and 12 hinges using the preferred embodiment of the prior art technology.

If it is desirable to use a considerably larger panel using the prior art technology, the panel should have been provided with a correspondingly larger number of through openings, for each of which there should have been provided a closing plate having for instance two to three hinges for each closing plate. If, for example, the area of the panel was doubled, this would have required the application of twice the number of closing plates and twice the number of hinges. Thus, instead of 4 closing plates with a total number of 12 hinges, 8 closing plates with 24 hinges must have been applied. A corresponding area can by applying the present invention be covered by only one closing unit with a few (1 to three) hinges, which makes manufacturing of the panel considerably cheaper.

Furthermore, using a system according to the present invention, maintenance is less complicated and cheaper due to the possibility of providing the actuators driving the system of panels in one single row at a position in the hall with easy access to the actuators without for instance having to remove seats in the hall totally or at least partly. This is especially important for systems according to the invention that are provided at the ceiling of a hall.

### BRIEF DESCRIPTION OF THE DRAWINGS

Further benefits and advantages of the present invention will become apparent after reading the detailed description of non-limiting exemplary embodiments of the invention in conjunction with the accompanying drawings, wherein:

FIGS. 1a and 1b show a schematic front and side view of a panel according to an embodiment of the invention;

FIGS. 2a and 2b show a schematic front and side view of the panel according to the embodiment of the invention shown in FIG. 1, where the panel is mounted on a wall of a room, such that a space is formed between the panel and the wall, in which space there is provided a sound absorbing material;

FIG. 3 shows a schematic side view of a panel according to an embodiment of the invention mounted on a wall, in which embodiment the closing unit is pivotally connected to the panel board, such that the closing unit can pivot between a closed state in which sound cannot propagate from the surroundings through the through openings in the panel board and arrive at the sound absorbing material and an open state in which sound can propagate through the through openings in the panel board and reach the sound absorbing material;

FIG. 4 shows a schematic side view of a panel according to another embodiment of the invention mounted on a wall, in which embodiment the closing unit is displaceable connected to the panel board, such that the closing unit can undergo a substantially parallel displacement relative to the panel board, whereby the closing unit can move between a closed state in which sound cannot propagate from the surroundings through the through openings in the panel board and arrive at the sound absorbing material and an open state in which sound can propagate through the through openings in the panel board and reach the sound absorbing material;

FIG. 5 shows an embodiment of the invention in which the closing unit is provided with a pattern of through openings that differs from that of the embodiments shown above in FIGS. 1 and 2;

FIG. 6 shows an alternative embodiment of a closing unit according to the invention;

FIG. 7 shows a schematic representation of an embodiment of a system according to the present invention provided with drive and actuator means;

FIG. 8 shows a schematic perspective representation of a panel board and a closing unit that illustrates some of the essential features of the invention;

FIG. 9 shows a perspective view of a mechanism configured to move the closing unit between the open and the closed states and vice versa substantially in parallel with the panel board;

FIG. 10 shows surrounding means that prevent sound energy to reach the absorption device in the closed state of the device;

FIG. 11 shows a further embodiment of the panel according to the invention that causes diffusion of the sound field outside of the panel when the panel is in its closed state; and

FIG. 12 shows two non-limiting examples of panels according to the invention provided with outwardly extending diffusing elements.

### DETAILED DESCRIPTION OF THE INVENTION

The principles of the invention will be illustrated by various embodiments hereof. It is however understood that a person skilled in the art may conceive other embodiments than those shown and described in the detailed description of the invention and that the scope of the invention is defined by the independent claims.

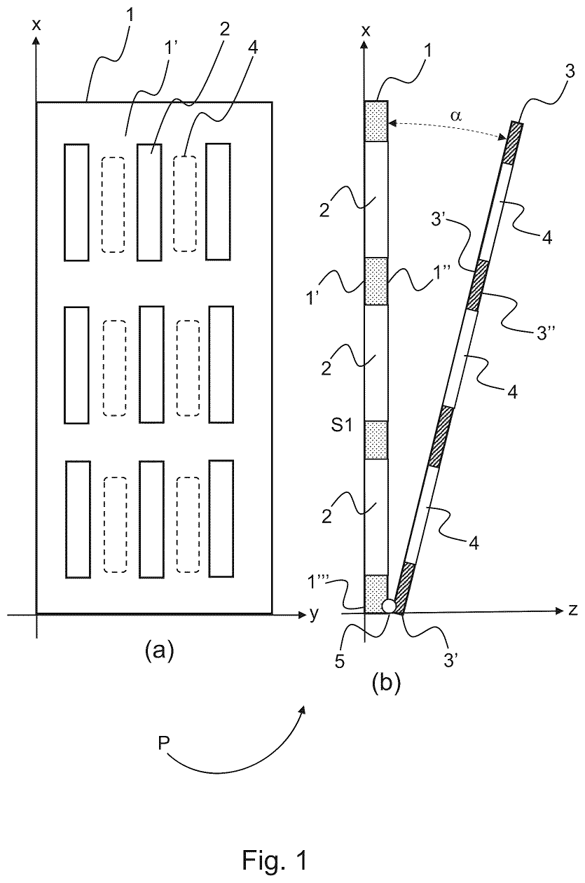

With reference to FIGS. 1a and 1b there are show a schematic front and side view of a panel according to an embodiment of the invention generally designated by reference sign P, wherein the panel comprises a panel board 1 for instance made of fiber gypsum. In the shown embodiment, the panel board 1 is planar and extends in and about the (x, y) plane as indicated in FIG. 1a, in which a first face 1′ of the panel board extends in the (x, y) plane. The panel board 1 comprises first and second surfaces 1′ and 1″, respectively, which can alternatively be referred to as the front and the rear surfaces 1′, 1″, respectively.

The panel board 1 is provided with a pattern of through openings 2 that in the shown embodiment are of a generally rectangular cross section. It is however understood that any shape and patterns of the panel boards and through openings in the panel boards as well as other closing units having the essential features of the invention may be used.

On the first surface 1′ of the panel board 1 there is in some embodiments of the invention be provided a sheet of veneer, which sheet is provided with through openings corresponding to those in the panel board. This sheet can give the panel board 1 an aesthetically attractive look when seen from the space S1 in front of the first surface 1′, whereby the look of the panel can be adapted to the use in for instance different concert halls or auditoria. Any desired surface appearance can be used.

The through openings 2 in the panel board 1 can according to the invention be opened and closed, such that sound can either propagate through the through openings 2 or be effectively prevented from this. This means, that the panel according to the present invention can either be in an open state, where sound can propagate through the through openings 2 or in a closed state, where sound cannot propagate the through openings 2. To this end the panel is provided with a closing unit 3 that in the embodiment shown in FIGS. 1a and 1b is pivotally attached to the panel board 1 by a hinge member 5 at one longitudinal end portion 1″ of the panel board 1. The closing unit 3 can pivot an angle α relative to the second surface 1″ of the panel board 1 between the open and closed states of the panel.

The closing unit 3 is according to the invention provided with a pattern of through openings 4 that are displaced relative to the through openings 2 in the panel board 1 as shown in FIG. 1(a), such that when the panel is in the closed state, the through openings 4 in the closing unit 3 do not overlap the through openings 2 in the panel board 1.

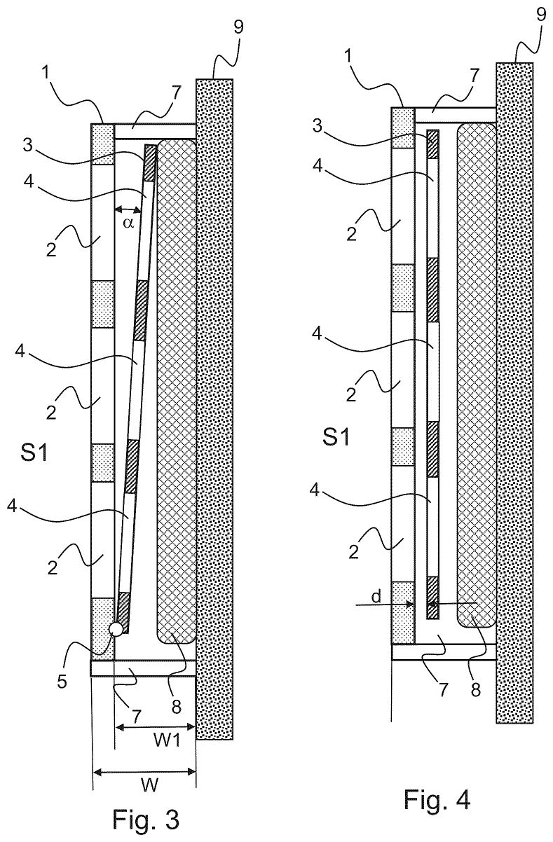

Providing the closing unit 3 with the through openings 4 has the very important result that the angle α in the open state of the panel can be very limited (much less than what is shown in FIG. 1(b)) and still ensure a sufficient propagation of sound energy through the panel in the open state hereof. This is illustrated in FIG. 3 (and also in FIG. 4, where the pivotal movement of the closing unit 3 is replaced by a displacement indicated by d. Employing a smaller angle a or smaller depth d of the panels, the total construction depth of the panels becomes smaller, thereby saving costly space.

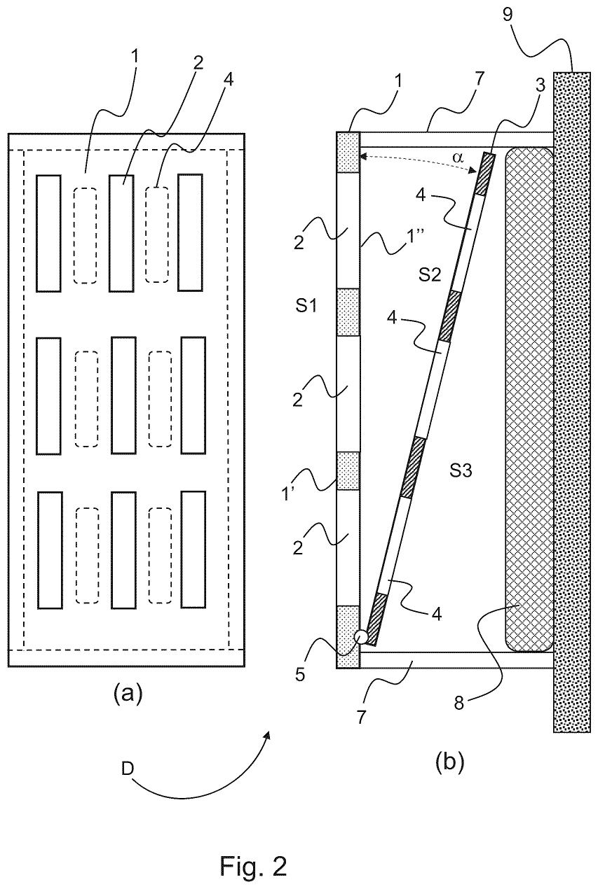

With reference to FIGS. 2a and 2b there are shown a schematic front and side view of a device according to the embodiment of the invention generally designated by reference sign D, comprising a panel as shown in FIG. 1, where the panel is mounted on a wall 9 of a room, such that a space S2 is formed between the panel board 1 and the closing unit 3 and the sound propagates further through the through openings 4 in the closing unit 3 and reaches space S3, in which space S3 there is provided a sound absorbing material 8, in which an amount of sound energy is then absorbed.

FIG. 2(a) and 2(b) thus shows a device that can be varied between an open state (as shown in FIG. 2(b) where sound is absorbed by the device and a closed state in which is reflected from the first (or front) surface 1′ of the panel board 1. This device thus comprises a panel according to the invention, suitable attachment means 7 configured to attach the panel to a boundary 9 of a room and a sound absorbing material 8 or other sound absorbing means or devices provided in the space formed between the panel 1 and the boundary 9. The device may further be provided with operating means that are configured to open and close the panel, although it is also possible to apply operating means that are configured to open and close a number of panels or devices according to the invention.

FIGS. 3 and 4 show a device according to the invention comprising a panel according to the invention mounted by attachment means 7 on a wall 9 at a short distance W from the wall 9. Mounting the panel board 1 as close as possible to the wall 9—or other boundary of a room—is very important for example in a concert hall, where a very large number of devices (may be several hundreds) must be used and where consequently deep panels (large W) would lead to a considerable reduction of the available space in the hall after installation of the devices. With reference to FIG. 3 there is shown a schematic side view of a device according to an embodiment of the invention mounted on a wall 9, in which embodiment the closing unit 3 is pivotally connected to the panel board 1 as shown by the angle α, such that the closing unit 30 can pivot between a closed state in which sound cannot propagate from the surroundings S1 through the through openings 2 in the panel board 1 and arrive at the sound absorbing material 8 and an open state in which sound can propagate through the through openings 2 in the panel board 1 and reach the sound absorbing material 8. In this embodiment, the panel board 1 is mounted on attachment means 7 a distance W from the wall 9 such that the depth W of the panel is only limited by the requirement that a sufficient acoustic passage is provided between the surroundings S1 and the sound absorbing material 8 in the open state of the panel.

With reference to FIG. 4 there is shown a schematic side view of a device according to another embodiment of the invention mounted on a wall 9, in which embodiment the closing unit 3 is displaceable connected to the panel board as indicated by arrow d, such that the closing unit 3 can undergo a substantially parallel displacement relative to the panel board 1, whereby the closing unit 3 can move between a closed state, in which sound cannot propagate from the surroundings S1 through the through openings 2 in the panel board 1 and arrive at the sound absorbing material 8 and an open state, in which sound can propagate through the through openings 2 in the panel board 1 and reach the sound absorbing material 8.

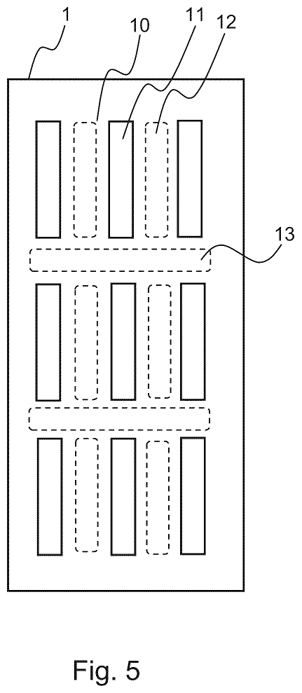

With reference to FIG. 5 there is shown a front view of an embodiment of the invention in which the closing unit 3 (not visible) is provided with a pattern of through openings 12 that differs from that of the embodiments shown above in FIGS. 1 and 2. The through openings in the panel board and closing unit can have any shape, form and pattern.

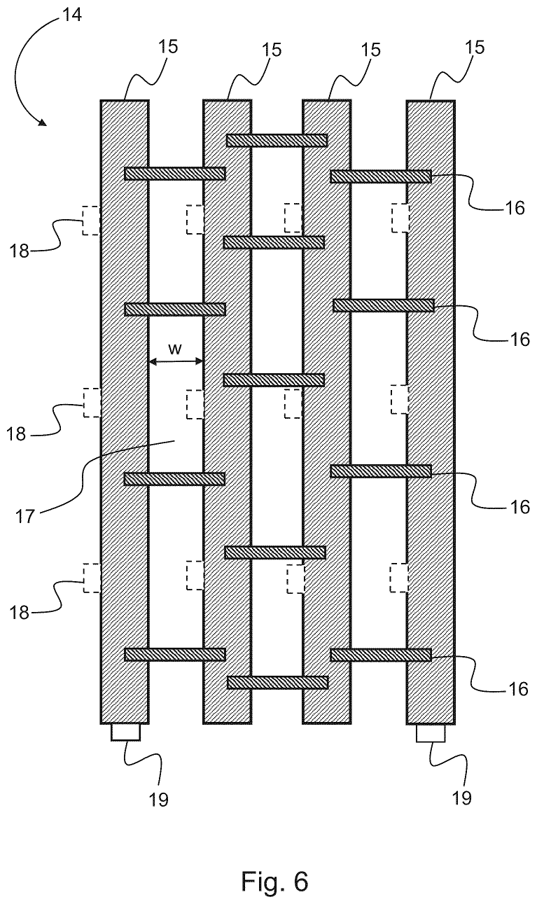

With reference to FIG. 6 there is shown an alternative embodiment of a closing unit according to the invention generally designated by reference numeral 14. This closing unit comprises a number (in the figure four) of closing members or plates 15 dimensioned such that they can close corresponding through openings in the panel board. Adjacent closing members 15 are connected by connecting members 16 such that a gab 17 of width w is formed between adjacent closing members 15. In the shown embodiment, the closing unit 14 is attached to the panel board (not shown) be means of hinges 19 such that the closing unit can undergo a pivotal movement relative to the panel board as described in connection with FIG. 2(b) and 3 above. It is understood that the closing unit shown in FIG. 6 could be opened or closed in any manner, for instance by parallel displacement relative to the panel board in the manner described above for the embodiment shown in FIG. 4.

Referring to the prior art modules described in WO 2018/162014 A1, the closing members 15 correspond to the closing plates described in this document, where each of these closing plates were provided with hinges 18 (shown in broken lines in FIG. 6) that enabled each individual of the closing plates to undergo a pivotal movement relative to the front face. As it clearly appears from FIG. 6, a panel with four through openings in the front face required a total of twelve hinges in the prior art modules, which number is reduced to only two hinges in the embodiment of the closing unit 14 according to the present invention.

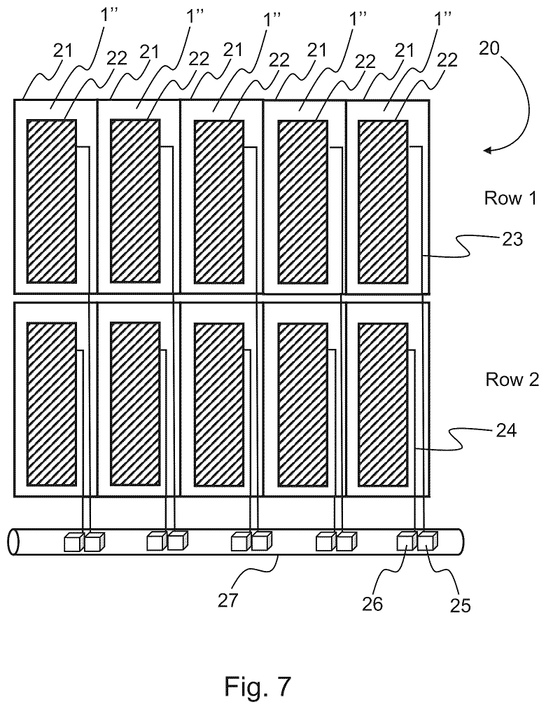

With reference to FIG. 7 there is shown a schematic and illustrative representation of an embodiment of a system according to the present invention generally designated by reference numeral 20. The shown system comprises two rows (Row 1 and Row 2) of panels 21 according to the present invention. The system is seen towards the second of rear surface 1″ of the panels 21 (c.f. FIG. 1 or 2) and shows schematically the respective closing units 22.

The respective closing units 22 are individually driven by drive members 23 (for the panels in Row 1) and 24 (for the panels in Row 2). At the longitudinal ends of the drive members 23, 24 these is attached to respective actuators 25, 26 that drive the movement of the corresponding closing unit 22. The actuators 25, 26 can, if desired, be provided in the form of a total assembly as indicated schematically by reference numeral 27.

A system according to the embodiment of the invention shown in FIG. 7 facilitates maintenance and/replacement of the actuators as these are not provided in or at each separate panels 21 but at a position outside the system that is easily accessible without having to remove chairs etc. from the room in which the panels are installed in order to get access to the actuators.

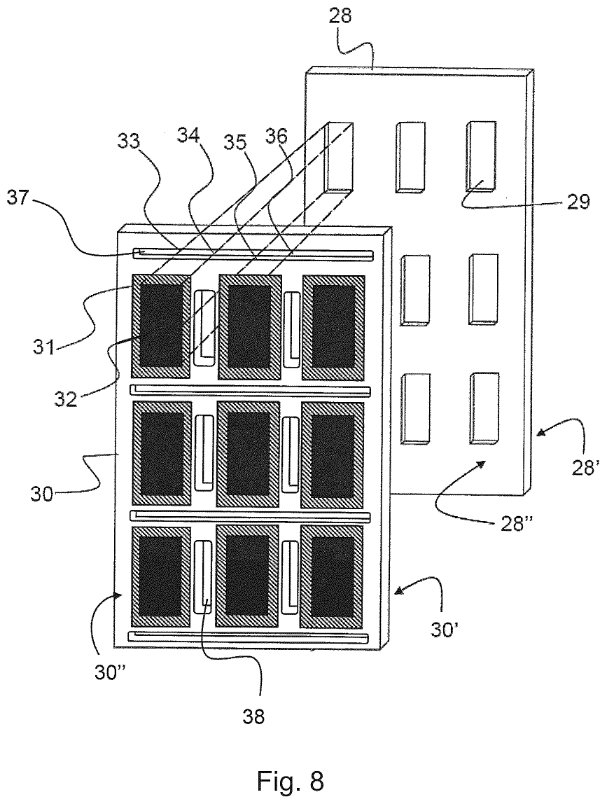

With reference to FIG. 8 there is shown a schematic perspective representation of a panel board 28 and a closing unit 30 that illustrates some of the essential features of the invention. The panel board 28 has a first surface 28′ and a second surface 28″ and is provided with a number of through openings 29. The second surface 28″ faces the closing unit 30.

The closing unit 30 has a first surface 30′ that faces the panel second surface 28″ of the panel board 28 as well as a second surface 30″ that in a practical installation will face a sound absorbing material or other sound absorbing device.

As indicated by the broken lines 33, 34, 35, 36, the respective through openings 29 in the panel board 28 correspond to the area 32 on the closing unit 30, which area 32 is sound-impenetrable. For the closing unit 30 to be able to close the through openings 29 in the panel board acoustically tight in the closed state of the panel according to the invention, the area 32 must be at least as big (and of the same form) as the corresponding through opening 29. In a practical implementation as somewhat bigger sound-impenetrable area 31 will be needed in order to obtain the required acoustically tight closing.

According to the invention, either substantially the entire remaining area of the closing unit 30, i.e. the area that is not covered by the areas 31 or chosen parts of this remaining area is configured such that sound can penetrate through the closing unit in this/these area/s. Practical examples hereof are shown in FIGS. 1 through 7 and described above. In FIG. 8, such areas are provided by the slits 37, 38 in the closing unit 30 that in the closed state of the panel do not overlap the through openings 29 in the panel board. It is understood that other configurations of sound penetrable areas in the closing unit could also be used, provided that these areas do not overlap with any of the sound-impenetrable areas 31, 32 of the closing unit 30.

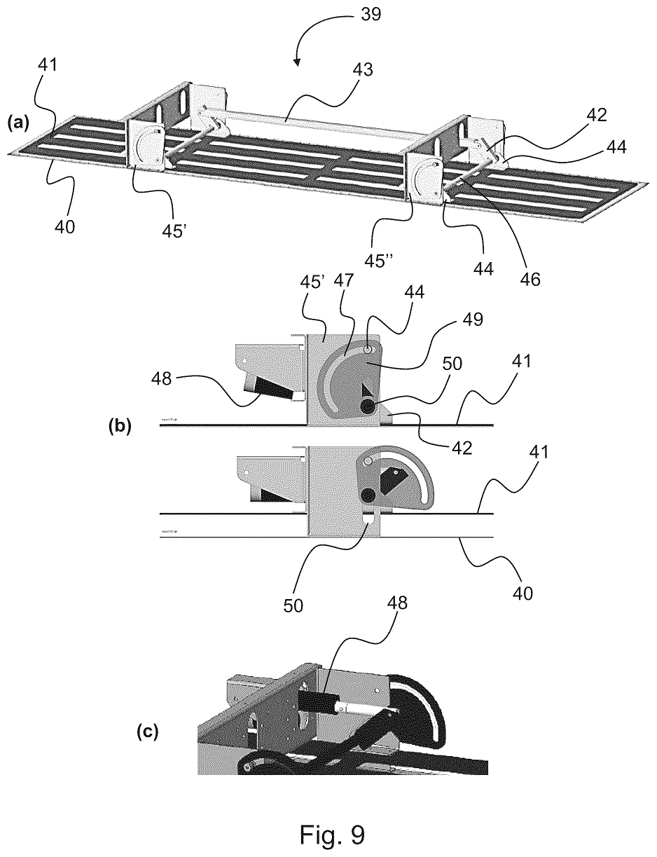

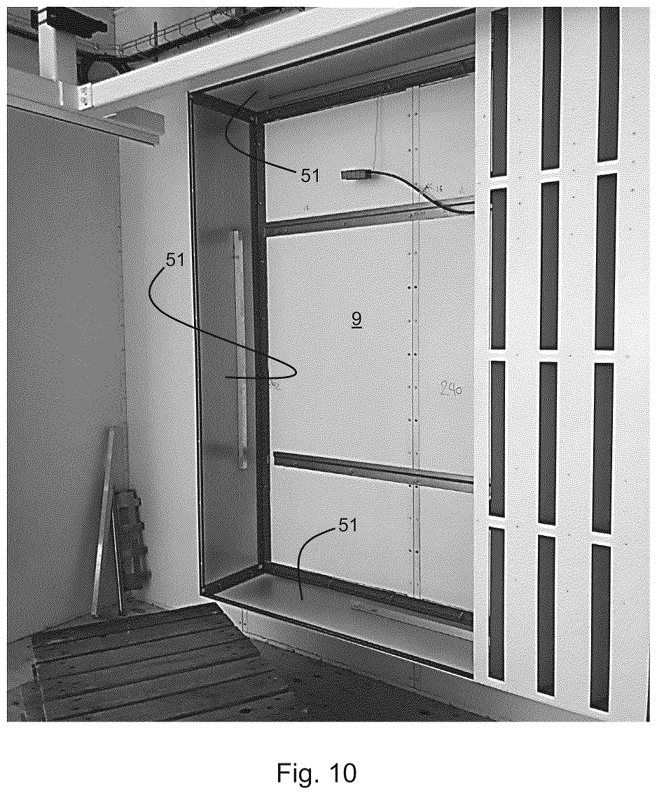

With reference to FIG. 9(a), (b) and (c) there is shown a mechanism configured to move the closing unit 39 between the open and the closed states and vice versa substantially in parallel with the panel board 40. The mechanism generally designated by reference numeral 39 comprises a pair of brackets 45″ and a pair of brackets 45″″ attached to the panel board 40. To the closing unit there are attached respective pairs of brackets 44 that connect the closing unit to the mechanism, such that the mechanism, when operated, can move the closing unit 41 parallel to the panel board 40 between the open and closed stated and vice versa. The mechanism 39 essentially comprises an operating arm member 42 for each pair of brackets that can be operated by an actuator 48. The arm members of the pair of brackets 45′, 45″ are connected by a longitudinally extending rod 43, such that a single actuator can operate both arm members 42. The arm member 42 is attached to a transversal shaft 46 extending between the brackets 45′, 45″ of each respective pairs of brackets. When the arm member 42 pivots under the action of the actuator 48, the shaft 46 rotates the plate member 49 as shown in FIG. 9(b), where the plate member 49 is provided with a groove 47, in which a tap 44 attached to the bracket respective bracket 45′, 45″ can move such that the shaft 46 can rotate a given angle determined by the length of the groove 47. An extension of the shaft 44 can move in grove 50 perpendicularly to the plane of the panel board 40 such that the rotation of the shaft 46 results in a movement of the closing unit 41 relative to and in parallel with the panel board 40 as shown in FIG. 9(b).

It is understood that other mechanisms than the one shown in FIG. 9 could alternatively be used and that such mechanisms would also fall within the scope of the invention.

With reference to FIG. 10 there is shown surrounding means 51 that prevent sound energy to reach the absorption device (indicated by reference numeral 8 in FIG. 2, but not present in the photo shown in FIG. 10) in the closed state of the device. Sound energy has to be prevented from entering the absorption device 8 shown in FIG. 2 through other paths that through the openings in the panel board, wherefor the panels need to be surrounded at their circumference by top-bottom-and side plates or other covering means, as shown in FIG. 10.

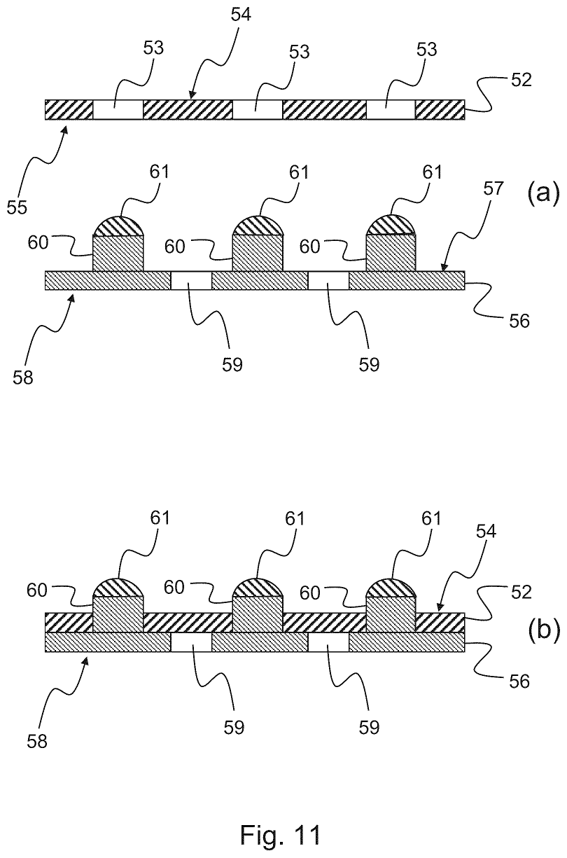

With reference to FIG. 11 there is shown a further embodiment of the panel according to the invention in which the closing unit 56 on the surface 57 that faces the rear surface 55 of the front panel 52 is provided with extension elements 60, 61 where each individual extension element is positioned and configures such that it in the closed state of the panel passes through the corresponding through opening 53 in the front panel 52 and extents a distance d in an outward direction from the outer surface 54 of the front panel. The presence of these outwardly extending elements causes a desirable diffusion of the sound field outside of the panel (i.e. in the room in which the panels according to the invention are installed), when the panel is in its closed state.

The outwardly extending elements may comprise two sections, an inner section 60 that in the closed state of the panel extends through the corresponding through opening in the panel board 52 to a distance d from the outer surface 54 of the the panel board 52 and an outer section 61 at the outer end portion of the first section 60 such that the total outward extension from the outer surface 54 of the panel board 52 is d_{T}.

The the dimension and geometrical shape of the inner and outer section depends on the dimension and shape of the corresponding through opening 53 in the panel board 52. Furthermore, the shape of the second section can be chosen such that a desired sound diffusion in the sound field in front of the panel can be obtained as best as possible. Typically, the second section 61 can have the shape of a spherical cap.

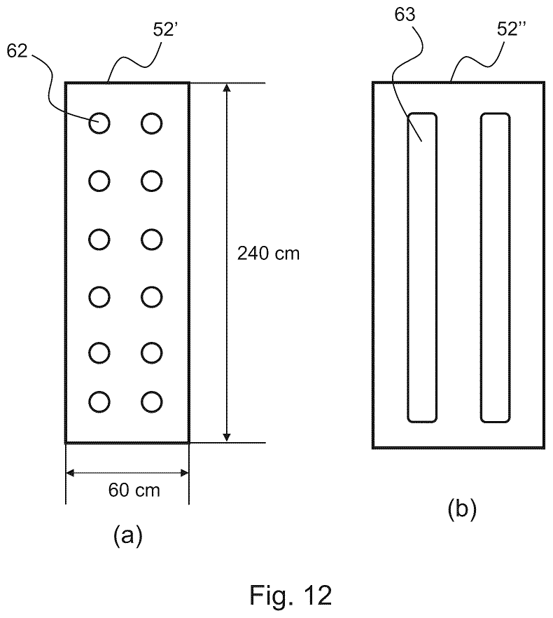

With reference to FIG. 12 there is shown plane frontal views of two non-limiting examples of panels according to the invention. These panels may or may not be provided with outwardly extending diffusing elements. It is also possible according to the invention to provide the corresponding closing unit with extension elements corresponding to some of the through openings in the panel board but not corresponding to the remaining through openings.

In FIG. 12 a, the dimensions of the panels 52′ and 52″ are 60 cm times 240 cm, but other dimensions could also be used. In FIG. 12a circular through openings 62 are used and in FIG. 12b longitudinally extending rectangular through openings 63 are used. As mentioned, extension elements may be used for all of, some of or none of the through openings 62, 63.

1. A panel for attachment to boundaries of a room, such as a concert hall, the panel comprising:
a panel board (1, 28) provided with through openings (2, 29) between a first surface (1′, 28′) and a second surface (1″, 28″) of the panel board (1, 28);
a closing unit (3, 14, 30) formed as a single plate movable relative to the panel board (1, 28) and configured to open and close all through openings (2, 29) in the panel board (1, 28), which plate (3, 14, 30) is provided opposite to and facing the second surface (1″, 28″) of the panel board (1, 28), such that the distance between the second surface (1″, 28″) of the panel board (1, 28) and the single plate (3, 14, 30) can be varied between a closed state, in which the plate (3, 14, 30) closes the through openings (2, 29) in the panel board (1, 28) and an open state, in which the plate (3, 14, 30) does not close the through openings (2, 29) in the panel board;
wherein the plate (3, 14, 30) in first regions (15, 32) of the plate (3, 14, 30) that in the closed state of the panel cover the through openings (2, 29) in the panel board (1, 28) is substantively sound impenetrable, so that sound is substantively prevented from being transmitted through the through openings (2, 29) in the panel board (1, 28) in the closed state of the panel; and
wherein the plate (3, 14, 30) in one or more second regions (4, 12, 13, 17, 37, 38) of the plate (3, 14, 30) that in the closed state of the panel are not totally or partly coinciding with said through openings (2, 29) in the panel board (1, 28) is configured such that it allows transmission of sound through the closing unit in said regions.

2. (canceled)

3. The panel according to claim 1, wherein the closing unit (3) is provided with through openings (4) that are displaced relative to the through openings (2) in the panel board (1), such that when the panel is in the closed state, the through openings (4) in the closing unit (3) do not overlap the through openings (2) in the panel board (1) whereby the closing unit (3) provides an acoustically tight closing of the through openings (2) in the panel board (1).

4. The panel according to claim 1, wherein the closing unit (3) in at least some of the regions that in the closed state of the panel coincides with the through openings in the panel board (1, 28) is provided with elements that extend from the surface of the closing unit that faces the panel board, which elements are configured such that they extend through at least some of the through openings in the front panel and to a distance (d) in front of the front panel when the panel is in the closed state.

5. The panel according to claim 1, wherein the closing unit (3) is pivotally (α) attached to the panel board (1), such that the closing unit (3) can vary the panel between a closed state and an open state, when the closing unit (3) pivots relative to the panel board (1).

6. The panel according to claim 5, wherein one longitudinal end (3′) of the closing unit (3) is pivotally attached to a corresponding longitudinal end (1″″) of the panel board (1) by means of a hinge member (5).

7. The panel according to claim 1, wherein the panel is configured such that the closing unit (3) can undergo a displacement substantially in parallel with the second surface (1″) of the panel board (1) such that the closing unit can be displaced a distance (d) between a position in which it closes the through openings (2) in the panel board and a position in which it opens the through openings (2) in the panel board (1).

8. The panel according to claim 1, wherein the closing unit is one single plate (3) provided with through openings (4).

9. The panel according to claim 1, wherein the closing unit (14) comprises a number of separate closing members (15), where adjacent closing members (15) are separated from each other by a gab (17) of a width (w), thereby forming the through openings in the closing unit (14).

10. The panel according to claim 1, wherein permanent magnetic means are provided on the second surface (1″) of the panel board (1) around the through openings (2) and wherein the closing unit at least in a region corresponding the position of the permanent magnets is made of a material that can be attracted by the magnetic means, such that the magnetic means, in the closed state of the panel, maintains the closing unit (3) is acoustically tight contact with the second surface (1″) of the panel board (1).

11. The panel according to claim 1, wherein electro-magnetic means are provided on the second surface (1′) of the panel board (1) around the through openings (2) and the closing unit at least in a region corresponding the position of the electro-magnets is made of a material that can be attracted by the magnetic means, such that the magnetic means, in the closed state of the panel, maintains the closing unit is acoustically tight contact with the second surface of the panel board.

12. The panel according to claim 1, wherein mechanical engagement means are provided on the second surface (1″) of the panel board (1) around the through openings (2) and wherein the closing unit at least in a region corresponding the position of the mechanical means is provided with cooperating releasable mechanical engagement means such that the mechanical engagement means, in the closed state of the panel, maintains the closing unit (3) is acoustically tight contact with the second surface (1″) of the panel board (1).

13. The panel according to claim 1, wherein the panel board (1) on the first surface (1′) is provided with a sheet, such as a sheet of veneer, which sheet is provided with through openings corresponding to the through openings (2) in the panel board (1).

14. The panel according to claim 1, wherein the panel comprises operator means configured to move the closing unit (3) between the open and closed states of the panel.

15. The panel according to claim 1, wherein both the panel board (1) and the closing unit (3, 14, 30) have the form of an arch, such that sound impinging on the front surface of the panel board (or on a sheet of veneer attached to the front surface of the panel board) becomes diffused, especially in the reflective (i.e, closed) state of the panel.

16. The device for varying the reverberation time (RT) of a room, such as a concert hall, where the device (D) comprises:
a panel according to claim 1;
a sound absorbing device, such as a sound absorbing material (8), provided such that the closing unit (3) can control the propagation of sound energy from the surroundings (S1) of the device to the sound absorbing device;
attachment means (7) configured to attach the panel to a boundary (9) of the room such that a space (S3) is formed between the panel and the boundary (9) in which space (S3) the sound absorbing device (8) is provided; and
operator means (23, 24, 39) configured to open or close the closing unit (3):
surrounding means (51) that prevent sound energy to reach the absorption device (8) in the closed state of the device.

17. A covering system for boundaries (9) of a room, wherein the system comprises:
one or more sound absorbing devices according to claim 16:
actuator means (25, 26), such as electric motors, configured to drive the operator means (23, 24) of the devices between the open and closed states of the panel and vice versa.

18. The system according to claim 17, wherein the actuators (25, 26) are configured to maintain the closing units (3) of the panels (P) in one or more states between an entirely closed state and a maximally open state of the closing units (3).
